(19) United States
(12) Patent Application Publication
(10) Pub. No.: US 2021/0042582 A1
(43) Pub. Date: Feb. 11, 2021

(54) SYSTEM AND METHOD FOR MONITORING HEALTH OF CROP TO VALIDATE CROP INSURANCE CLAIM

(71) Applicant: ZUNA INC., San Jose, CA (US)

(72) Inventors: VIDYADHAR HANDRAGAL, SAN JOSE, CA (US); KRISTOPHER LE, Milpitas, CA (US); PRAKASH HATTI, Bangalore (IN); PREM ANAND, Bangalore (IN)

(73) Assignee: ZUNA INC., San Jose, CA (US)

(21) Appl. No.: 16/535,526

(22) Filed: Aug. 8, 2019

(51) Int. Cl. G06K 9/62; G06Q 40/08; G06Q 50/02

(52) U.S. Cl. CPC G06K 9/6262; G06K 9/6227; G06K 2209/27; G06Q 50/02; G06Q 40/08

(57) ABSTRACT

A system for monitoring health of crop to validate crop insurance claim is disclosed. The system includes monitoring sensors to capture images of the farm at a predefined time interval. The system includes a processing subsystem to process captured images of the farm using image pre-processing techniques, a meta data extraction subsystem to extract meta data corresponding to each crop of the farm from each of the one or more captured images, a decentralized classifier subsystem to store extracted meta data on a blockchain based storage platform, a decentralized classifier subsystem includes an image recognition classifier subsystem to perform time stamping on the extracted meta data in the blockchain based storage platform corresponding to each of the one or more captured images and a validation subsystem is to monitor health of each crop, by accessing time stamped meta data from the blockchain based storage platform, to validate crop insurance claim.

### BACKGROUND

Embodiments of a present disclosure relate to artificial intelligence based agricultural insurance claim validation and more particularly to a system and a method for monitoring health of crop to validate crop insurance claim.

Agriculture has played a vital role all over the globe. In agriculture, crops are annual, and the growth rate of crops is determined by the seasons. The crops are strongly affected by human activities and management where timely and accurate monitoring information is required. The monitoring of crops includes crop identification, crop growth monitoring, environmental parameters, crop damage and crop disaster monitoring. To monitor, manage and produce profit out of it, the producers have therefore looked to business models and financial planning to help maintain a profitable operation. Unfortunately, the business models and the system presently available suffer from various deficiencies.

One such system for providing agricultural financial services is conventionally available. The system includes crop insurance services, where a proper level of crop insurance is determined by validating the insurance claim using manual monitoring the crops. However, such system for monitoring and predicting crop insurance for agricultural purposes are not well refined. Most of the systems lack solutions to overcome the agricultural based insurance crisis.

Furthermore, another such type of advance systems uses Blockchain technology. The Blockchain technology has a variety of applications, many of which have found themselves in the field of insurance to reduce claim disputes. However, there is no recourse to prove the previous state of crops for insurance claims. Such process is fairly involved and requires the claimant to jump through multiple legal hoops to ensure a successful claim. Moreover, there does exist one system in which a blockchain has been used to create proof against video camera footage to see its authenticity and to check if it's been treated. However, the main problem with using such a system is that, the video camera footage alone does not provide the whole story as to why the crops have died off or given a poor yield to validate the claims.

Hence, there is a need for an improved system and method for monitoring health of crop to validate crop insurance claim to address the aforementioned issues.

### BRIEF DESCRIPTION

In accordance with an embodiment of the present disclosure, a system for monitoring health of crop to validate crop insurance claim is provided. The system includes a plurality of monitoring sensors located on a farm. The plurality of monitoring sensors includes an image acquisition device which is configured to capture one or more images of the farm at a predefined time interval. The system includes a processing subsystem, located on a server, and operatively coupled to the plurality of monitoring sensors. The processing subsystem includes an image processing subsystem configured to process one or more captured images of the farm using a plurality of image pre-processing techniques. The processing subsystem also includes a meta data extraction subsystem operatively coupled to the image processing subsystem. The meta data extraction subsystem is configured to extract meta data corresponding to each crop of the farm from each of the one or more captured images. The processing subsystem further includes a decentralized classifier subsystem operatively coupled to the meta data extraction subsystem. The decentralized classifier subsystem is configured to store extracted meta data on a blockchain technology based storage platform. The decentralized classifier subsystem includes an image recognition classifier subsystem configured to perform time stamping on the extracted meta data in the blockchain technology based storage platform corresponding to each of the one or more captured images. The processing subsystem further includes a validation subsystem operatively coupled to the decentralized classifier subsystem. The validation subsystem is configured to monitor health of each crop of the farm, by accessing time stamped meta data from the blockchain technology based storage platform, to validate crop insurance claim.

In accordance with an embodiment of the present disclosure, a method for monitoring health of crop to validate crop insurance claim is provided. The method includes capturing, by a plurality of monitoring sensors, one or more images of the farm at a predefined time interval. The method also includes processing, by an image processing subsystem, one or more captured images of the farm using a plurality of image pre-processing techniques. The method further includes extracting, by a meta data extraction subsystem, meta data corresponding to each crop of the farm from each of the one or more captured images. The method further includes storing, by a decentralized classifier subsystem, extracted meta data on a blockchain technology based storage platform. The method further includes performing, by an image recognition classifier subsystem, time stamping on the extracted meta data in the blockchain technology based storage platform corresponding to each of the one or more captured images. The method further includes monitoring, by a validation subsystem, health of each crop of the farm, by accessing time stamped meta data from the blockchain technology based storage platform, to validate crop insurance claim.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system for monitoring health of crop to validate crop insurance claim in accordance with an embodiment of the present disclosure:

FIG. 2 is a schematic representation of an exemplary embodiment of the system for monitoring health of crop to validate crop insurance claim of FIG. 1 in accordance with an embodiment of the present disclosure;

FIG. 3 is a block diagram of a computer or a server in accordance with an embodiment of the present disclosure; and

FIG. 4 is a flow chart representing the steps involved in a method for monitoring health of crop to validate crop insurance claim of FIG. 1, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”. “an”, and “the” include plural references unless the context clearly dictates otherwise.

Embodiments of the present disclosure relate to a system and method for monitoring health of crop to validate crop insurance claim is provided. The system includes a plurality of monitoring sensors located on a farm. The plurality of monitoring sensors includes an image acquisition device which is configured to capture one or more images of the farm at a predefined time interval. The system includes a processing subsystem, located on a server, and operatively coupled to the plurality of monitoring sensors. The processing subsystem includes an image processing subsystem configured to process one or more captured images of the farm using a plurality of image pre-processing techniques. The processing subsystem also includes a meta data extraction subsystem operatively coupled to the image processing subsystem. The meta data extraction subsystem is configured to extract meta data corresponding to each crop of the farm from each of the one or more captured images. The processing subsystem further includes a decentralized classifier subsystem operatively coupled to the meta data extraction subsystem. The decentralized classifier subsystem is configured to store extracted meta data on a blockchain technology based storage platform. The decentralized classifier subsystem includes an image recognition classifier subsystem configured to perform time stamping on the extracted meta data in the blockchain technology based storage platform corresponding to each of the one or more captured images. The processing subsystem further includes a validation subsystem operatively coupled to the decentralized classifier subsystem. The validation subsystem is configured to monitor health of each crop of the farm, by accessing time stamped meta data from the blockchain technology based storage platform, to validate crop insurance claim.

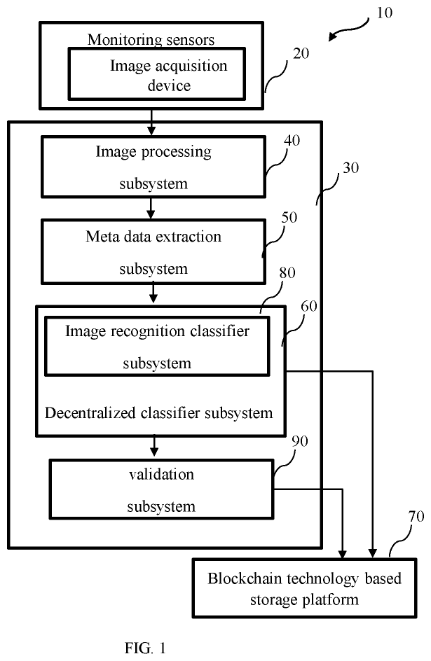

FIG. 1 is a block diagram representation of a system 10 for monitoring health of crop to validate crop insurance claim in accordance with an embodiment of the present disclosure. The system 10 includes a plurality of monitoring sensors located on a farm. The plurality of monitoring sensors 20 includes an image acquisition device which is configured to capture one or more images of the farm at a predefined time interval. In one embodiment, the plurality of monitoring sensors 20 may include a camera. In another embodiment, the plurality of monitoring devices may include at least one of a physiological sensor, a surface analysis sensor and a chemical sensor which are configured to monitor ambient conditions such as illumination, soil moisture, soil temperature, carbon dioxide and nutrients present in soil. The system 10 also includes a processing subsystem 30, located on a server, and operatively coupled to the plurality of monitoring sensors 20. In one embodiment, the server may include a cloud based server. In another embodiment, the server may include a local server.

Furthermore, the processing subsystem 30 includes an image processing subsystem 40 configured to process one or more captured images of the farm using a plurality of image pre-processing techniques. The one or more images captured by the plurality of monitoring sensors 20 restrain errors related to geometry and brightness values of the pixels. Such errors are corrected using appropriate the plurality of image pre-processing techniques which are either definite or statistical models. In some embodiment, the plurality of image pre-processing techniques may include an image enhancement technique which is the modification of one or more images by changing the pixel brightness values to improve its visual impact. The image enhancement technique involves a collection of techniques that are used to improve the visual appearance of one or more images, or to convert the one or more images to a form which is better suited for human or machine interpretation.

In such embodiment, the image enhancement technique may include a contrast stretching technique, a global thresholding technique, a histogram equalisation technique, a log transformations technique, a power law transformations technique and a sharpening filters technique.

The processing subsystem 30 further includes a meta data extraction subsystem 50 which is operatively coupled to the image processing subsystem 40. The meta data extraction subsystem 50 is configured to extract meta data corresponding to each crop of the farm from each of the one or more captured images. As used herein, the term “meta data of an image” is defined as text information pertaining to the image file that is embedded into a file or contained in a separate file that is associated with it. The metadata includes details relevant to the image as well as information about the production of the image. In one embodiment, the meta data corresponding to each crop of the farm may include a crop identification number, crop name, presence of disease, name of the disease and time stamp.

Moreover, the processing subsystem 30 further includes a decentralized classifier subsystem 60 which is operatively coupled to the meta data extraction subsystem 50. The decentralized classifier subsystem 60 is configured to store extracted meta data on a blockchain technology based storage platform 70. As used herein, the term “blockchain technology based storage platform” is defined as a decentralized, distributed and public digital ledger that is used to record data across many computing devices so that any involved data cannot be altered retroactively, without the alteration of all subsequent blocks.

In one embodiment, the decentralized classifier subsystem 60 is configured to verify the legitimacy and originality of the one or more captured images in the blockchain technology based storage platform 70 based on one or more classification techniques. The first stage classification takes place to ensure that the meta data has not been captured from another camera or is a doctored image. In such embodiment, the one or more classification techniques may include a supervised classification technique or an unsupervised classification technique.

The decentralized classifier subsystem 60 includes an image recognition classifier subsystem 80 configured to perform time stamping on the extracted meta data in the blockchain technology based storage platform 70 corresponding to each of the one or more captured images. In one embodiment, the time stamping may be a variable which may be programmed with the plurality of monitoring device. The decentralized classifier subsystem 60 is configured to time stamp each of the one or more images captured by the plurality of monitoring sensors 20 located in farm with information relating to each crop's health on the blockchain technology based storage platform 70 based on a YOLO (you only look once) framework. In one embodiment, the time stamped meta data present within each block of the blockchain technology based storage platform 70 may be accessed via an application programming interface (API) which is present on the server.

In addition, the processing subsystem 30 further includes a validation subsystem 90 which is operatively coupled to the decentralized classifier subsystem 60. The validation subsystem 90 is configured to monitor health of each crop of the farm, by accessing time stamped meta data from the blockchain technology based storage platform 70, to validate crop insurance claim. In some embodiments, the validation subsystem 90 may be configured to validate the crop insurance claim by matching the time stamped meta data corresponding to each crop of the farm with a crop insurance claim document stored in a storage subsystem (not shown FIG. 1). In such embodiment, the storage subsystem may be located on a server and configured to store one or more images captured every hour and buffer data.

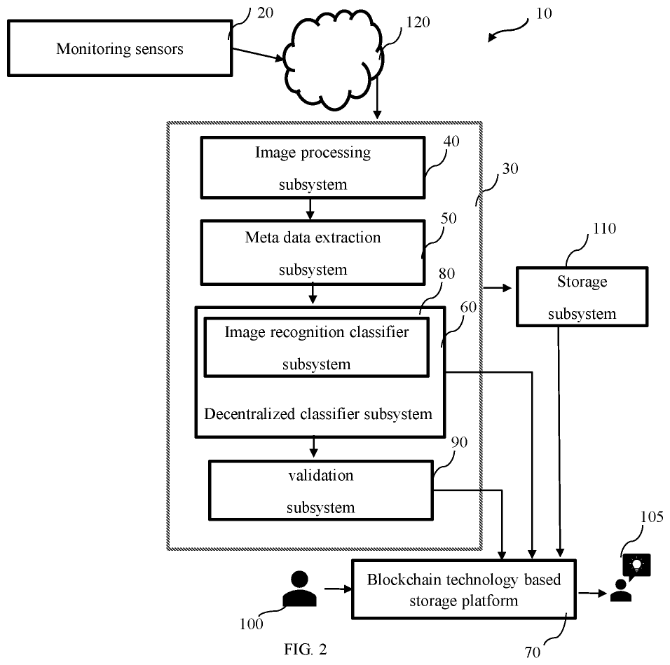

FIG. 2 is a schematic representation of an exemplary embodiment of the system 10 for monitoring health of crop to validate crop insurance claim of FIG. 1 in accordance with an embodiment of the present disclosure. Since the advent of agriculture, farmers have confronted unpredictable weather conditions in their work. One way that farmers protect themselves from weather and commodities risk is through crop insurance. However, processing crop insurance claims is often a slow process and hinders farmers. From an insurance provider perspective, processing large number of claims for each weather crisis puts tremendous operational burden on its workforce. Hence, the system 10 is provided which monitors the health of the crop of a farm of the farmer and enables an insurer 105 to validate crop insurance claims based on the data obtained from the monitored health of the crop. Considering an example in which a farmer ‘x’ 100 due to bad weather experiences losses in crop and applied for claiming the insurance. The system 10 includes a storage subsystem 110 which stores crop insurance claim document of farmer ‘x’ 100.

The system 10 includes a plurality of monitoring sensors 20 such as a camera which is located on a farm of the farmer ‘x’ 100. The plurality of monitoring sensors 20 captures one or more images of the farm at every one hour. The one or more images captured by the plurality of monitoring sensors 20 are transferred to a processing subsystem 30 of the system 10 via a communication subsystem 120. The processing subsystem 30 is located on a cloud based server.

The processing subsystem 30 receives the one or more images from the plurality of monitoring sensors 20. The processing subsystem 30 includes an image processing subsystem 40 configured to process one or more captured images of the farm using a plurality of image pre-processing techniques. The one or more images captured by the plurality of monitoring sensors 20 restrain errors related to geometry and brightness values of the pixels. Such errors are corrected using appropriate the image enhancement technique such as a contrast stretching technique, a global thresholding technique, a histogram equalisation technique, a log transformations technique, a power law transformations technique and a sharpening filters technique.

The processing subsystem 30 further includes a meta data extraction subsystem 50 which is operatively coupled to the image processing subsystem 40. The meta data extraction subsystem 50 is configured to extract meta data corresponding to each crop of the farm from each of the one or more captured images. The meta data extraction subsystem 50 may extracts a crop identification number, crop name, presence of disease, name of the disease and time stamp data about the crop of the farmer ‘x’ 100.

Furthermore, the processing subsystem 30 further includes a decentralized classifier subsystem 60 which is operatively coupled to the meta data extraction subsystem 50. The decentralized classifier subsystem 60 is configured to store extracted meta data on a blockchain technology based storage platform 70. The blockchain based storage platform 70 enables identifying and tracking meta data digitally and sharing such information across a distributed network of computers, the decentralized classifier subsystem 60 is configured to verify the legitimacy and originality of the one or more captured images in the blockchain technology based storage platform 70 based on one or more classification techniques. The first stage classification takes place to ensure that the meta data has not been captured from another camera or is a doctored image.

Subsequently, the decentralized classifier subsystem 60 includes an image recognition classifier subsystem 80 configured to perform time stamping on the extracted meta data in the blockchain technology based storage platform 70 corresponding to each of the one or more captured images. The decentralized classifier subsystem 60 is configured to time stamp each of the one or more images captured by the plurality of monitoring sensors 20 located in farm with information relating to each crop's health on the blockchain technology based storage platform 70 based on a YOLO (you only look once) framework. The time stamped meta data present within each block of the blockchain technology based storage platform 70 may be accessed via an application programming interface (API) which is present on the server and may be accessed by an insurance company or the insurer 105 via same API.

The validation subsystem 90 of the processing subsystem 30 is configured to monitor health of each crop of the farm, by accessing time stamped meta data from the blockchain technology based storage platform 70, to validate crop insurance claim. The insurance company or the insurer 105 validates the crop insurance claim by matching the time stamped meta data corresponding to each crop of the farm with a crop insurance claim document stored in the storage subsystem 110.

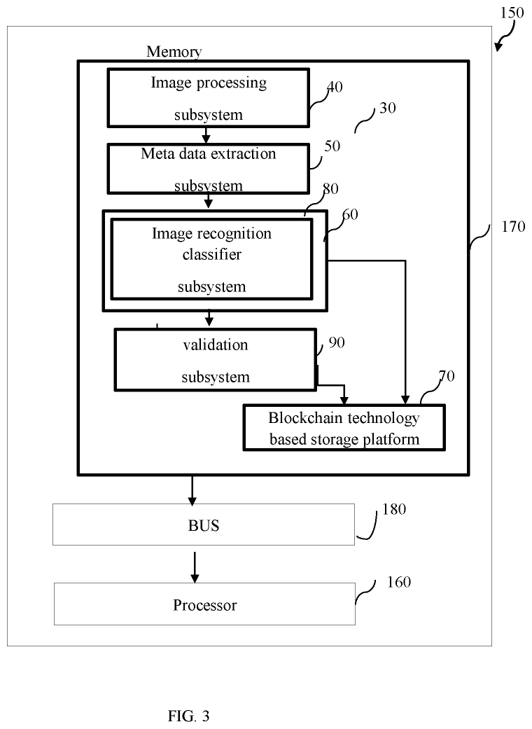

FIG. 3 is a block diagram of a computer or a server 150 in accordance with an embodiment of the present disclosure. The server 150 includes processor(s) 160, and memory 170 coupled to the bus 180. As used herein, the processor 160 and memory 170 are substantially similar to processing subsystem 30 of FIG. 1.

The processor(s) 160, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 170 includes a plurality of modules stored in the form of executable program which instructs the processor 160 to perform the method steps illustrated in FIG. 1. The memory 170 has following modules: the image processing subsystem 40, the meta data extraction subsystem 50, the decentralized classifier subsystem 60 which further includes image recognition classifier subsystem 80 and the validation subsystem 90. The image processing subsystem 40 configured to process one or more captured images of the farm using a plurality of image pre-processing techniques. The meta data extraction subsystem 50 operatively coupled to the image processing subsystem 40. The meta data extraction subsystem 50 is configured to extract meta data corresponding to each crop of the farm from each of the one or more captured images.

The decentralized classifier subsystem 60 operatively coupled to the meta data extraction subsystem 50. The decentralized classifier subsystem 60 is configured to store extracted meta data on a blockchain technology based storage platform 70. The decentralized classifier subsystem 60 includes an image recognition classifier subsystem 80 configured to perform time stamping on the extracted meta data in the blockchain technology based storage platform 70 corresponding to each of the one or more captured images. The validation subsystem 90 operatively coupled to the decentralized classifier subsystem 60. The validation subsystem 70 is configured to monitor health of each crop of the farm, by accessing time stamped meta data from the blockchain technology based storage platform 70, to validate crop insurance claim.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable program stored on any of the above-mentioned storage media may be executable by the processor(s) 160.

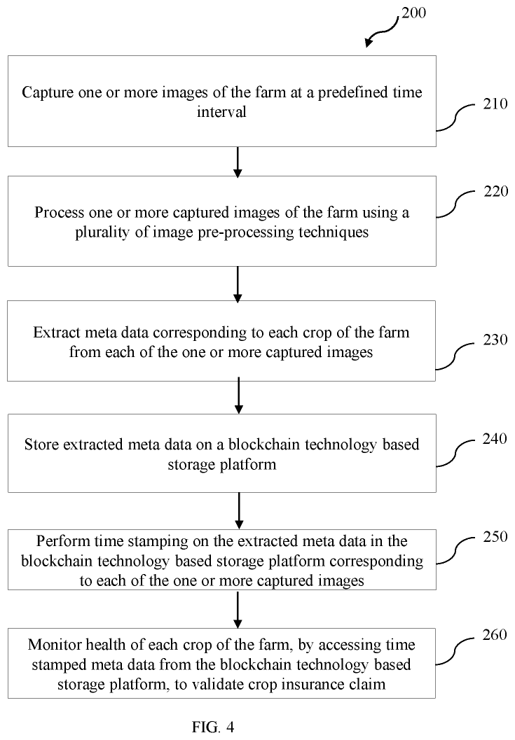

FIG. 4 is a flow chart representing the steps involved in a method 200 for monitoring health of crop to validate crop insurance claim of FIG. 1 in accordance with an embodiment of the present disclosure. The method 200 includes capturing one or more images of the farm at a predefined time interval in step 210. In one embodiment, capturing one or more images of the farm at the predefined time interval may include capturing one or more images of the farm at the predefined time interval by a plurality of monitoring sensors. In such embodiment, capturing one or more images of the farm at the predefined time interval may include capturing one or more images of the farm at the predefined time interval by a camera.

Furthermore, the method 200 includes processing one or more captured images of the farm using a plurality of image pre-processing techniques in step 220. In one embodiment, processing the one or more captured images of the farm using the plurality of image pre-processing techniques may include processing the one or more captured images of the farm using the plurality of image pre-processing techniques by an image processing subsystem. In some embodiment, processing the one or more captured images of the farm using the plurality of image pre-processing techniques may include processing the one or more captured images of the farm using an image enhancement technique, wherein the image enhancement technique comprises a contrast stretching technique, a global thresholding technique, a histogram equalisation technique, a log transformations technique, a power law transformations technique and a sharpening filters technique.

Moreover, the method 200 includes extracting meta data corresponding to each crop of the farm from each of the one or more captured images in step 230. In one embodiment, extracting meta data corresponding to each crop of the farm from each of the one or more captured images may include extracting meta data corresponding to each crop of the farm from each of the one or more captured images by a meta data extraction subsystem. In some embodiments, extracting meta data corresponding to each crop of the farm from each of the one or more captured images may include extracting crop identification number, crop name, presence of disease, name of the disease and time stamp from each of the one or more captured images.

In addition, the method 200 includes storing extracted meta data on a blockchain technology based storage platform in step 240. In one embodiment, storing the extracted meta data on the blockchain technology based storage platform may include storing the extracted meta data on the blockchain technology based storage platform by a decentralized classifier subsystem. The method 200 further includes performing time stamping on the extracted meta data in the blockchain technology based storage platform corresponding to each of the one or more captured images in step 250. In one embodiment, performing time stamping on the extracted meta data in the blockchain technology based storage platform corresponding to each of the one or more captured images ma include includes performing time stamping on the extracted meta data in the blockchain technology based storage platform corresponding to each of the one or more captured images by an image recognition classifier subsystem.

The method 200 further includes monitoring health of each crop of the farm, by accessing time stamped meta data from the blockchain technology based storage platform, to validate crop insurance claim in step 260. In one embodiment, monitoring health of each crop of the farm, by accessing time stamped meta data from the blockchain technology based storage platform, to validate crop insurance claim may include monitoring health of each crop of the farm, by accessing time stamped meta data from the blockchain technology based storage platform, to validate crop insurance claim by a validation subsystem. In some embodiments, the method 200 may include verifying the legitimacy and originality of the one or more captured images in the blockchain technology based storage platform based on one or more classification techniques. In such embodiment, verifying the legitimacy and originality of the one or more captured images in the blockchain technology based storage platform based on one or more classification techniques may include verifying the legitimacy and originality of the one or more captured images in the blockchain technology based storage platform based on one or more classification techniques by the decentralized classifier subsystem.

In a specific embodiment, the method 200 may include validating the crop insurance claim by matching the time stamped meta data corresponding to each crop of the farm with a crop insurance claim document stored in a storage subsystem. In such embodiment, validating the crop insurance claim by matching the time stamped meta data corresponding to each crop of the farm with the crop insurance claim document stored in the storage subsystem may include validating the crop insurance claim by matching the time stamped meta data corresponding to each crop of the farm with the crop insurance claim document stored in the storage subsystem by the validation subsystem.

Various embodiments of the system and method for monitoring health of crop to validate claim insurance claim described above enables a decentralized classifier subsystem to track the health of crops on such a large scale in a tightly integrated system. The system includes a ledger on the blockchain which is immutable, hence this alone provides us with evidence that the one or more images and its corresponding components have not been doctored.

Furthermore, the system repudiates falsified data and make the insurance claiming process more hassle free and reduce the huge premiums that small-scale farmers will have to pay. The system provides an agricultural insurance monitoring and prediction method which is quick and cost efficient as well as it also helps one of the socio-economic issues of farmers. The system helps to extract more data in much lesser span of time and extract all relevant data leading to agriculture/crop.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for monitoring health of crop to validate crop insurance claim comprising:
a plurality of monitoring sensors located on a farm, wherein the plurality of monitoring sensors comprises an image acquisition device configured to capture one or more images of the farm at a predefined time interval;
a processing subsystem, located on a server, and operatively coupled to the plurality of monitoring sensors, wherein the processing subsystem comprises:
an image processing subsystem configured to process one or more captured images of the farm using a plurality of image pre-processing techniques;
a meta data extraction subsystem operatively coupled to the image processing subsystem, wherein the meta data extraction subsystem is configured to extract meta data corresponding to each crop of the farm from each of the one or more captured images;
a decentralized classifier subsystem operatively coupled to the meta data extraction subsystem, wherein the decentralized classifier subsystem is configured to store extracted meta data on a blockchain technology based storage platform,
wherein the decentralized classifier subsystem comprises:
an image recognition classifier subsystem configured to perform time stamping on the extracted meta data in the blockchain technology based storage platform corresponding to each of the one or more captured images; and
a validation subsystem operatively coupled to the decentralized classifier subsystem, wherein the validation subsystem is configured to monitor health of each crop of the farm, by accessing time stamped meta data from the blockchain technology based storage platform, to validate crop insurance claim.

2. The system of claim 1, wherein the plurality of monitoring sensors comprises a camera.

3. The system of claim 1, wherein the plurality of monitoring sensor comprises at least one of a physiological sensor, a surface analysis sensor and a chemical sensor.

4. The system of claim 1, wherein the plurality of image pre-processing techniques comprises an image enhancement technique, wherein the image enhancement technique comprises a contrast stretching technique, a global thresholding technique, a histogram equalisation technique, a log transformations technique, a power law transformations technique and a sharpening filters technique.

5. The system of claim 1, wherein the meta data corresponding to each crop of the farm comprises a crop identification number, crop name, presence of disease, name of the disease and time stamp.

6. The system of claim 1, wherein the decentralized classifier subsystem is configured to verify the legitimacy and originality of the one or more captured images in the blockchain technology based storage platform based on one or more classification techniques.

7. The system of claim 1, wherein the validation subsystem is configured to validate the crop insurance claim by matching the time stamped meta data corresponding to each crop of the farm with a crop insurance claim document stored in a storage subsystem.

8. A method comprising:
capturing, by a plurality of monitoring sensors, one or more images of the farm at a predefined time interval;
processing, by an image processing subsystem, one or more captured images of the farm using a plurality of image pre-processing techniques;
extracting, by a meta data extraction subsystem, meta data corresponding to each crop of the farm from each of the one or more captured images;
storing, by a decentralized classifier subsystem, extracted meta data on a blockchain technology based storage platform;
performing, by an image recognition classifier subsystem, time stamping on the extracted meta data in the blockchain technology based storage platform corresponding to each of the one or more captured images; and
monitoring, by a validation subsystem, health of each crop of the farm, by accessing time stamped meta data from the blockchain technology based storage platform, to validate crop insurance claim.

9. The method of claim 8, wherein extracting meta data corresponding to each crop of the farm from each of the one or more captured images comprises extracting crop identification number, crop name, presence of disease, name of the disease and time stamp from each of the one or more captured images.

10. The method of claim 8, further comprising verifying, by the decentralized classifier subsystem, the legitimacy and originality of the one or more captured images in the blockchain technology based storage platform based on one or more classification techniques.

11. The method of claim 8, further comprising validating, by the validation subsystem, the crop insurance claim by matching the time stamped meta data corresponding to each crop of the farm with a crop insurance claim document stored in a storage subsystem.
